(19) United States
(12) Patent Application Publication
(10) Pub. No.: US 2022/0175100 A1
(43) Pub. Date: Jun. 9, 2022

(54) HELMET BAG WITH INTEGRATED THERMAL CONTAINMENT COMPARTMENT

(71) Applicant: FliSS LLC, San Diego, CA (US)

(72) Inventor: Joana Shuckerow, San Diego, CA (US)

(21) Appl. No.: 17/457,151

(22) Filed: Dec. 1, 2021

Related U.S. Application Data
(60) Provisional application No. 63/121,141, filed on Dec. 3, 2020.

(51) Int. Cl. A45C 3/00; A45C 13/36; B32B 5/26; B32B 19/06

(52) U.S. Cl. CPC A45C 3/001; A45C 13/36; A45C 2013/1015; B32B 19/06; B32B 5/26

(57) ABSTRACT

A flexible helmet bag including an integrated first compartment for holding a pilot's helmet and a second compartment for safely carrying and containing an electronic device that includes a battery capable of thermal runaway. The second compartment is configured to contain a mobile device, for example, a tablet computer, a laptop, and a smart phone. the second compartment includes a first flexible wall coupled to a second flexible wall to forming a cavity therebetween. The third wall can include a fiberglass material positioned adjacent to the cavity, an aramid material, and a silica fabric material or a carbon fiber material positioned between the fiberglass material and the aramid material. The fourth wall can include a fiberglass material positioned adjacent to the cavity, an aramid material, and a silica fabric material or a carbon fiber material positioned between the fiberglass material and the aramid material.

### BACKGROUND OF THE INVENTION

### Field of the Invention

The present invention relates to a safety article that includes a fire-resistant compartment structured for containing a battery runaway event and a protective compartment for transporting the helmet of a pilot, and that is flexible for easy storage in an aircraft cockpit.

### Description of the Related Art

Helmets used by military pilots are sophisticated, incorporating a number of specialized communication, visual and safety components. In addition to a helmet, military pilots are typically issued a helmet bag. Although the amount of gear a pilot can bring with them into a relatively small military aircraft cockpit is limited, as part of flying protocol, a pilot may carry a helmet bag, or some form of a flight bag, with them on a flight to carry and protect their helmets in transit into and out of the aircraft. The helmet bags are lightweight, allowing them to be rolled-up and stowed securely during flight in the limited available storage space in an aircraft cockpit. Nearly all pilots also carry, and have onboard their aircraft, one or more mobile computing devices computers (for example, a smart phone, tablet computer, or a laptop computer), which may be used for communication, notes, flight checklists, flight planning, tracking, and the like. In addition, aircraft themselves can be equipped with one or more additional mobile computing devices (“mobile devices”). At high altitudes and high temperatures, a battery in a mobile device (e.g., a lithium battery) may explode, ignite, or have a thermal runaway event, causing the battery and its surrounding material to smolder, ignite, and burn. Fumes, smoke, and fire in an aircraft are dangerous conditions can cause catastrophic results including injuries, damage or loss of the aircraft, and death. Accordingly, it would be advantageous to limit the risk of lithium batteries having thermal runaway events and igniting while taking into account the limited amount of gear that is available in a military aircraft cockpit.

### SUMMARY OF THE INVENTION

Embodiments of the invention relate to an integrated helmet bag having a flexible, fire-resistant or fireproof containment compartment for containing a lithium battery, or a mobile device having a lithium battery, during a thermal runaway event of the battery. The containment compartment is structured with strong, insulated, fire-resistant, explosive containing walls that are also flexible, allowing the helmet bag to be rolled-up, or folded-up, and stowed in a small space of an aircraft, for example, an aircraft cockpit. The helmet bag includes another compartment, coupled to the first compartment which is configured for holding and protecting a helmet of a pilot.

One innovation includes a helmet bag with an integrated thermal containment compartment, the helmet bag, comprising a first compartment including a flexible first wall positioned on a distal side of the helmet bag, a flexible second wall, a first cavity between the first wall and the second wall for holding a helmet, the first wall coupled to the second wall along a first portion of a perimeter of the first cavity, a first opening along a second portion of the perimeter of the first cavity for receiving a helmet into the first cavity, and a first fastener attached along the second portion of the first compartment, the first fastener configured to temporarily close the first opening. the helmet bag further comprises a second compartment including a flexible third wall coupled to the second wall, a flexible fourth wall positioned on the proximal side of the helmet bag such that the third wall is between the first compartment and the fourth wall, a second cavity between the third wall and the fourth wall for holding an electronic device, the third wall coupled to the fourth wall along a first portion of a perimeter of the second cavity, wherein the third wall includes an inner layer comprising fiberglass material positioned adjacent to the second cavity, an outer layer comprising an aramid material, and a middle layer comprising one of a silica fabric material or a carbon fiber material positioned between the inner layer and the outer layer, and wherein the fourth wall includes an inner layer comprising fiberglass material positioned adjacent to the second cavity, an outer layer comprising an aramid material, and a middle layer comprising one of a silica fabric material or a carbon fiber material positioned between the inner layer and the outer layer of the fourth wall, a second opening along a second portion of the perimeter of the second cavity for receiving an electronic device into the second cavity, and a second fastener attached along the second portion of the perimeter of the second cavity, the second fastener configured to temporarily close the second opening. Various embodiments can include one or more other features. In some embodiments, the width of the second compartment is less than or equal to the width of the first compartment, and the height of the second compartment is less than or equal to the height of the first compartment. In some embodiments, the volume of the first cavity is greater than the volume of the second cavity. In some embodiments, the middle layer of the third wall and the middle layer of the fourth walls include silica fabric material. In some embodiments, the middle layer of the third wall and the middle layer of the fourth walls include carbon fiber material. In some embodiments, the width dimension of the first compartment and the width dimension of the second compartment are within plus or minus 2″ of each other. In some embodiments, the first compartment has a height of between 15″ and 30″ and a width of between 15″ and 30″. In some embodiments, the second compartment has a height dimension of between 7″ and 22″ and a width dimension of between 10″ and 23″. In some embodiments, the second fastener is configured to close the second opening with a non-airtight seal. In some embodiments, the second fastener comprises hook-and-loop fasteners. In some embodiments, the second fastener comprises one of a zipper, hook and loop fasteners, a snap, a button, or a structure that extends over the opening and covers the opening.

Another innovation includes a helmet bag with an integrated thermal containment compartment, the helmet bag, comprising a first compartment including a flexible first wall positioned on a distal side of the helmet bag, a flexible second wall, a first cavity between the first wall and the second wall having dimensions for holding a pilot's helmet, the first wall coupled to the second wall along a first portion of a perimeter of the first cavity, a first opening along a second portion of the perimeter of the first cavity for receiving a helmet into the first cavity, and a first fastener attached along the second portion of the first compartment, the first fastener configured to temporarily close the first opening. The helmet bag further includes a second compartment including a flexible third wall coupled to the second wall, a flexible fourth wall positioned on the proximal side of the helmet bag such that the third wall is between the first compartment and the fourth wall, a second cavity between the third wall and the fourth wall having dimensions for holding an electronic device, the third wall and the fourth wall each comprising two or more layers of material and are structured to contain heat and smoke of a thermal runaway event of an electronic device in the second compartment, a second opening along a second portion of the perimeter of the second cavity for receiving an electronic device into the second cavity, and a second fastener attached along the second portion of the perimeter of the second cavity, the second fastener configured to temporarily close the second opening. Various embodiments can include one or more other features. In some embodiments, the third wall and the fourth wall each comprise a flexible outer layer comprising Nomex®, a flexible middle layer comprising silica fabric, and a flexible inner layer comprising fiberglass. In some embodiments, the third wall and the fourth wall each comprise a flexible outer layer comprising Nomex®, a flexible middle layer comprising carbon fiber, and a flexible inner layer comprising fiberglass. In some embodiments, the first compartment has a height of between 15″ and 30″ and a width of between 15″ and 30″. In some embodiments, the second compartment has a height dimension of between 7″ and 22″ and a width dimension of between 10″ and 23″. In some embodiments, the second fastener is configured to close the second opening with a non-airtight seal. In some embodiments, the second fastener comprises hook-and-loop fasteners.

Another innovation includes a helmet bag with an integrated thermal containment compartment, the helmet bag, comprising a first compartment including a flexible first wall positioned on a distal side of the helmet bag, a flexible second wall, and a first cavity between the first wall and the second wall having dimensions for holding a pilot's helmet, the first wall coupled to the second wall along a first portion of a perimeter of the first cavity, and a second compartment including a flexible third wall coupled to the second wall, a flexible fourth wall positioned on the proximal side of the helmet bag such that the third wall is between the first compartment and the fourth wall, a second cavity between the third wall and the fourth wall having dimensions for holding an electronic device, the third wall and the fourth wall each comprising two or more layers of material and are structured to contain heat and smoke of a thermal runaway event of an electronic device in the second compartment, and a second fastener attached along an opening on a perimeter of the second cavity, the second fastener configured to temporarily close the opening with a non-airtight seal. In some embodiments of such a helmet bag, the third wall and the fourth wall each comprise a flexible outer layer comprising Nomex®, a flexible middle layer comprising one of silica fabric or carbon fiber, and a flexible inner layer comprising fiberglass.

### BRIEF DESCRIPTION OF THE DRAWINGS

The features and advantages of the devices and methods described herein will become more fully apparent from the following description and appended claims, taken in conjunction with the accompanying drawings. These drawings depict only several embodiments in accordance with the disclosure and are not to be considered limiting of its scope. In the drawings, similar reference numbers or symbols typically identify similar components, unless context dictates otherwise. In some instances, the drawings may not be drawn to scale.

FIG. 1 is a perspective view of an example of an embodiment of a flexible helmet bag that includes a compartment for holding a pilot's helmet and a compartment for safely carrying and containing an electronic device including a battery;

FIG. 2 is a proximal side elevational view of the embodiment of the helmet bag of FIG. 1;

FIG. 3 is a distal side elevational view of the embodiment of the helmet bag of FIG. 1;

FIG. 4 is a schematic illustrating example dimensions of the helmet bag illustrated in FIG. 1, according to various embodiments;

FIG. 5 is a schematic illustrating an example of a top view of a helmet bag;

FIG. 6 is an exploded perspective view illustrating layers of four walls of an embodiment of a helmet bag, where in this example a first wall includes at least three layer, a second wall is coupled to the first wall and includes at least three layers, a third wall is coupled to the second wall and includes at least three layers, and a fourth wall is coupled to the third wall and includes at least three layers.

### DETAILED DESCRIPTION OF CERTAIN INVENTIVE ASPECTS

The following detailed description is directed to certain embodiments of the invention. However, the invention can be embodied in a multitude of different ways. It should be apparent that the aspects herein may be embodied in a wide variety of forms and that any specific structure, function, or both being disclosed herein is merely representative of one or more embodiments of the invention.

Embodiments of the invention relate to a helmet bag having multiple compartments coupled together to form a single, flexible article that is configured to both hold and protect a pilot's helmet, and configured to hold and contain a battery (e.g., a lithium battery), or a mobile computer device (“mobile device”) that includes a battery, protecting the environment outside the bag from heat and/or fire during a thermal runaway event of the battery. A thermal runaway event, as used herein, refers to a battery (or a mobile device containing the battery) heating-up above it's normal operating temperature, and smoldering and/or igniting such that heat above the battery's normal operating temperature is generated. During a thermal runaway event, smoke, fumes, fire, and/or an explosion are generated from the battery, or from the mobile device that is exposed to the battery. When a thermal runaway event occurs in a battery that is in an aircraft, typically there is no place to place the battery/mobile device to contain the heat, smoke, fumes, and flames generated from the thermal runaway event. In military aircraft where the pilot is confined to the cockpit, space is extremely limited. However, there is already a place in a cockpit where the pilot stores their helmet bag. Therefore, a helmet bag having a flexible specialized containment compartment designed to contain a battery undergoing a thermal runaway event, obviates the need for having an additional piece of gear in the cockpit. The helmet bag with a flexible specialized containment compartment allows the helmet bag to be stowed in space already allocated for storage of the helmet bag (e.g., rolled-up or folded to fit into a minimum amount of space), thus adhering to existing operational protocols while significantly increasing safety, while providing an easily accessed containment compartment for isolating the “hot” battery. In addition, the portable containment compartment, along with the entire helmet bag, can be quickly removed from the aircraft, and even jettisoned if necessary. placing the containment adding a significant safety advantage over permanently installed containment systems.

Embodiments of an improved helmet bag described herein include a first compartment. The first compartment is structured to hold and protect a pilot's helmet. The first compartment can have a first wall, a second wall, and a first cavity between the first and second wall. The first cavity is sized to hold a pilot's helmet. In some embodiments, the first wall includes multiple layers. For example, two or more layers. In an example, the first wall includes three layers. In some examples, the first wall includes more than three layers. In some embodiments, the second wall includes multiple layers. For example, two or more layers. In an example, the second wall includes at least three layers. In some examples, the second wall includes more than three layers.

The helmet bag also includes a second compartment. The second compartment is coupled to the first compartment such that the helmet bag is an integrated article that includes (at least) the first and second compartment. In some embodiments, the helmet bag can include one or more additional compartments for holding a variety of items. The second compartment is configured to hold and contain a lithium battery, or a mobile device having a lithium battery. The second compartment is configured to contain heat and fire that may occur when a battery has a thermal runaway (or ignition) event. The second compartment includes a third wall, a fourth wall, and a second cavity between the third and fourth wall. The second cavity is sized to hold a mobile computer device and/or a battery. In some embodiments, the third wall includes multiple layers. For example, at least two layers. In some examples, the third wall includes three layers. In some examples, the third wall includes more than three layers. In some embodiments, the fourth wall includes multiple layers. For example, at least two layers. In some examples, the fourth wall includes three layers. In some examples, the fourth wall includes more than three layers.

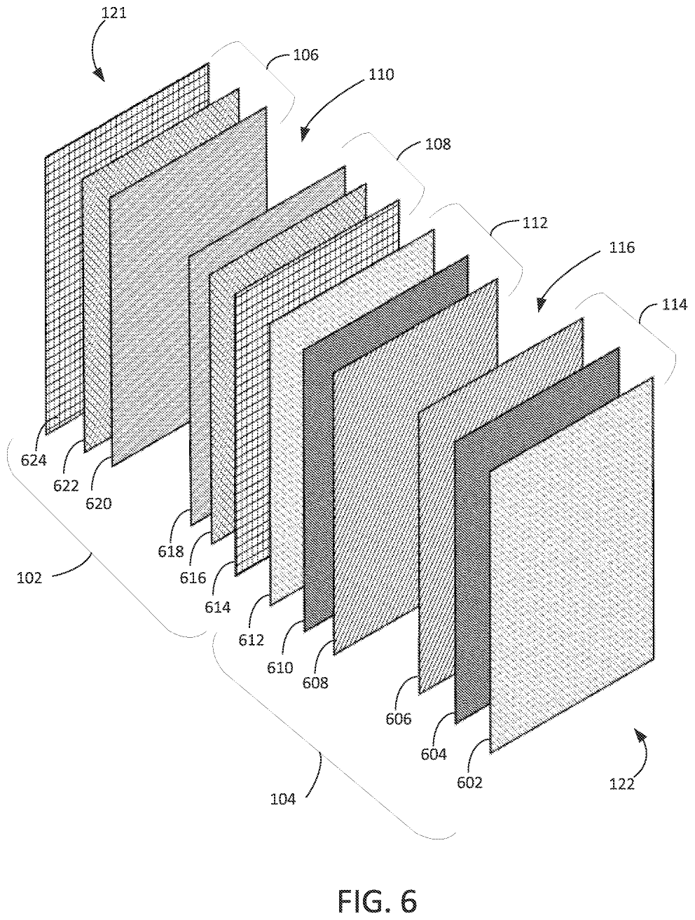

The third and fourth walls of the second compartment can include (at least) three layers to provide heat containment and insulation, protection from explosion, and protection of the environment outside the helmet bag. For example, an inner layer arranged closet to the second cavity, an outer layer arranged farthest from the second cavity, and a middle layer positioned between the inner layer and the outer layer. FIG. 6 shows an example of the third wall 112 and the fourth wall 114, and an example of the arrangement of layers that are used to construct the third wall 112 and the fourth wall 114. Still referring to FIG. 6, the third wall 112 includes an outer layer 612, a middle layer 610, and an inner layer 608; the fourth wall 114 includes an inner layer 606, a middle layer 604, and an outer layer 602. In some embodiments, additional layers are used to form the third and fourth walls. The inner layers of the third and fourth walls of the second compartment (near the second cavity) can be a heat-shielding and fire-resistant layer. For example, the inner layers can be an insulation layer comprising fiberglass capable of withstanding high temperatures and containing the maximum temperature a lithium battery will reach when undergoing thermal runaway. For example, in some embodiments the inner layer comprises Prepreg 7781 E-glass available from Fibre Glast Developments Corporation, Brookville, Ohio:

### Properties:

Style 7781

Finish 627

Weave Pattern 8 HS

Yarn Description Warp: ECDE 75 1/0 Fill: ECDE 75 1/0

Count: Ends×Picks (in) 57×54

Weight 8.71 oz/yd2

Breaking Strength (lb/in) Warp: 242 lb/in Fill: 231 lb/in

Thickness 0.0089 inches

### Neat Resin Properties:

Density (g/cc) 1.21

Tg (° F./° C.) (from G″ DMA curve) 255/124

Tensile Modulus (ksi/GPa) 410/2.8

Tensile Strength (ksi/MPa) 11.5/79.0

Elongation at Break (%) 4.5

Tg after 24-Hr Water-Boil (° F./° C.) 169/76*

Water Absorption % 3.9*

### Cure:

| Cure Target Temperature | Hold For |
|---|---|
| 310° F. (154° C.) | 1 Hour |
| 290° F. (143° C.) | 2 Hours |
| 270° F. (132° C.) | 4 Hours |

The middle layer of the third and fourth walls can reinforce the walls, providing further insulation and can be corrosion resistant, chemically stable, and have a high tensile strength which will ensure the containment of a potential explosion. In some embodiments, the middle layer comprises a flexible carbon fiber material. For example, a KRECA carbon fiber from Kureha Corporation, Tokyo, Japan. In an example, the middle layer of the third and fourth wall comprises a KRECA Felt, for example, one of Kreca Felt C, Kreca Felt G, or Kreca Felt X shown in the table below:

# measuring method: Kureha standard test method

| | | | KRECA | | KRECA | | KRECA | | |
|---|---|---|---|---|---|---|---|---|---|
| | | | FELT C | | FELT G | | FELT X | | |
| | | | F-105 | F-110 | F-205 | F-210 | F-205X | F-207X | F-210X |
| Typical Mass | | g/m² | 500 | 1000 | 500 | 1000 | 500 | 700 | 1000 |
| Typical | | Mm | 8 | 16 | 8 | 16 | 5 | 7 | 10 |
| Thickness | | | | | | | | | |
| Min. Carbon | | Wt % | >95 | | >99 | | >99 | | |
| Content | | | | | | | | | |
| Ash | Standard | ppm | <200 | | <200 | | <200 | | |
| | Type | | | | | | | | |
| Electrical | | Ω · m | 10~15 × 10⁻³ | | 4~5 × 10⁻³ | | 10~15 × 10⁻³ | | |
| Resistivity | | | | | | | | | |
| Average | In Vac. | W/m/K | 0.27 | | 0.27 | | 0.30 | | |
| Thermal | | | | | | | | | |
| Conductivity* | | | | | | | | | |

| | | | |
|---|---|---|---|
| In N₂ | 0.46 | 0.46 | 0.50 |

*At 1,000 degrees Celsius, test pieces with 50 mm thickness

In some embodiments, the middle layer comprises a silica fabric. In various examples, silica fabric is a type of fireproof silica fiber cloth with a high SiO₂ content that is used as a high temperature insulator for fire and thermal protection. TCC silica fabric can be used for long periods of time without losing its insular properties and without vaporizing or melting at temperatures as high as 1000° C. (1,832° F.). These properties make silica fabric excellent for industrial uses that include welding and fire safety. Silica fabric is a type of fine woven silica fiber that is similar to fiberglass. TCC silica fabrics are flame resistant, ecologically clean (offer 98% purity-free of organic resin binder), low thermal conductivity, and low electrical conductivity. TCC woven silica products are ideal for insulating engines as well as construction of compensators and other electrical equipment manufacturing. Silica fabrics are often used as heat shields to prevent surrounding components from overheating and significantly help reduce thermal loss in the process. Silica fabrics offer high chemical stability to alkali and acid media, are fungi-proof and resistant to other attacking microorganisms. In an example, the silica fabric is KA-600P-W, which can be obtained from The Chemical Company, Jamestown, R.I. Characteristics for KA-600P-W are shown in the table below:

| | | High - Silica Fabric | | |
|---|---|---|---|---|
| | | Service temperature up to 1000° C. | | |
| | | KA - 600P - W | | |
| | Characteristic | with vermiculite coating | | Test method |
| 1. | Weave | 8H Satin | | |
| 2. | Selvage | Feather | | |
| | | (Feather length 5-8 mm) | | |
| 3. | Yarn, tex warp | 68 × 3 or 34 × 6 | | |
| | weft | 68 × 3 or 34 × 6 | | |
| 4. | Diameter of | 6 | DE | |
| | filament, nom., μm | | | |
| 5. | Width | 92 +2/−1 cm | 36.2 + 0.8/0.4 inch | DIN EN 1773 |
| 6. | Thickness* | 0.67 +/− 0.07 MM | 0.026 +/− 0.003 INCH | DIN EN ISO 5084 |
| 7. | Weight | 600 +/− 30 g/m² | 17.7 +/− 0.9 oz/yd² | DIN EN 12127 |
| 8. | Thread count warp | 19 +/− 1 per cm | 48.3 +/− 2.5 per inch | DIN 53853 |
| | weft | 13 +/− 1 per cm | 33.0 +/− 2.5 per inch | |
| 9. | Tensile strength warp | 2800 N/5 cm | 320 lbs/inch | EN ISO 13934.1 |
| | min. weft | 1900 N/5 cm | 217 lbs/inc | |
| 10. | Content of main Sio₂ | 95 +/− 1 | | Comp. Method |
| | components % Al₂O₃ | 3.5 +/− 0.5 | | PP − Q K 02 |
| 11. | Roll length, nom. | 50 m | 50 yd | |

The low thermal conductivity of the inner layers and the middle layers of the third and fourth walls can have a low coefficient of thermal expansion to ensure that heat will not deform or melt the containment bag. The inner layers and middle layers can be biologically inert. The fiberglass like material is an electrical insulator even at low thickness. It also has low thermal conductivity allowing the heat to be contained within the pocket itself. The high tensile strength in conjunction with the chemical resistance will also contain the battery material as well as toxic fumes.

The outer layer of the third and fourth walls can be a material that provides further containment and protection of the environment outside of the helmet bag from a thermal event occurring in a battery in the second compartment. In some embodiments, the last layer of the pocket can be an aramid-like material, which is highly resistant to temperature, chemical degradation, and abrasion. It does not melt or drip and has the ability to extinguish fire thus reinforcing inner and middle layers. The outer layer is constructed to ensure all material emitted from any device in the second compartment is properly contained. In some embodiments, an outer layer includes Kevlar®, for example, a Kevlar® weave. In an example, an outer layer is Kevlar® 29 or Kevlar 49 from DuPont™. In an example, the outer layer comprises Kevlar® plain weave, 1500d 5 oz/170 grams) from DuPont™. In another example, an outer layer comprises Nomex®. For example, Nomex® 410 from Dupont™. In some embodiments, the outer layers of the third and fourth walls can be constructed of different materials. For example, one can comprise Nomex® and the other can comprise Kevlar®. However, it can be advantageous for manufacturing efficiencies and cost considerations to make the outer layers of the third and fourth walls from the same material. In some embodiments, the outer layer of the third and fourth walls has a thickness of about 0.05-0.1 mm. However, to ensure the outer layer has substantial strength and is still flexible enough such that the helmet bag can be rolled-up and stowed, in some preferred embodiments, the outer layer of the third and fourth walls has a thickness of about 0.05-0.076 mm. For example, in a particular preferred embodiment, the outer layer of the third and fourth walls has a thickness of about 0.076 mm. The combination of the materials used for the layers of the third and fourth walls creates a robust insolation capable withstanding high temperatures. In the event of an explosion the materials will contain any sparks, and any fragments of the battery avoiding the need for an ejection.

In some embodiments, the second compartment includes an opening which can be closed using marine grade hook and loop fasteners (e.g., Velcro®) to ensure smoke containment and ease of access during an emergency. The smoke and heated air in the second compartment will not be fully contained in order to prevent further pressure build up and a potential secondary explosion. The combination of the characteristics of the materials of the layers of the third and fourth walls creates a robust insolation capable withstanding high temperatures. In the event of a battery explosion the second compartment will contain any sparks, and any fragments of the battery, mitigating the risk of a fire that would result in the loss or damage of the aircraft, and/or the ejection of the pilot.

The following is a list of certain annotations and components that are described and enumerated in this disclosure in reference to the above-listed figures. However, any aspect, structure, feature or operational function of the devices illustrated in the figures, whether or not named out separately herein, can form a portion of various embodiments of the invention and may provide basis for one or more claim limitation relating to such aspects, with or without additional description. The annotations and enumerated components include:

| | |
|---|---|
| 100 | helmet bag |
| 102 | first compartment (helmet |
| | compartment) |
| 104 | second compartment (fire |
| | containment compartment) |
| 106 | first wall |
| 108 | second wall |
| 110 | first cavity |
| 112 | third wall |
| 114 | fourth wall |
| 116 | second cavity |
| 118 | first cavity opening |
| 120 | second cavity opening |
| 121 | distal side |
| 122 | proximal side |
| 124 | first fastener |
| 126 | second fastener |
| 128 | first portion of perimeter first |
| | compartment |
| 130 | second portion of perimeter first |
| | compartment |
| 132 | first portion of perimeter of second |
| | compartment |
| 134 | second portion of perimeter of |
| | second compartment |
| 136 | first end |
| 138 | second end |
| 140 | handle |
| 142 | strap fastener |
| 144 | top |
| 146 | bottom |
| 148 | lower portion |
| 206 | electronic device |
| 210 | flap |
| 212 | top |
| 214 | bottom |
| 302 | strap |
| 304 | first outside pocket |
| 306 | second outside pocket |
| 308 | fastener, first outside pocket |
| 310 | fastener, second outside pocket |
| 602 | 1^{st} material (outer layer) of 4^{th} wall |
| 604 | 2^{nd} material (a middle layer) of 4^{th} |
| | wall |
| 606 | 3^{rd} material (interior layer) of 4^{th} |
| | wall |
| 608 | 3^{rd} material (interior layer) of 3^{rd} |
| | wall |
| 610 | 2^{nd} material (a middle layer) of 3^{rd} |
| | wall |
| 612 | 1^{st} material (outer layer) of 3^{rd} wall |
| 614 | 1^{st} material (outer layer) of 2^{nd} wall |
| 616 | 2^{nd} material (a middle layer) of 2^{nd} |
| | wall |
| 618 | 3^{rd} material (interior layer) of 2^{nd} |
| | wall |
| 620 | 3^{rd} material (interior layer) of 1^{st} |
| | wall |
| 622 | 2^{nd} material (a middle layer) of 1^{st} |
| | wall |
| 624 | 1^{st} material (outer layer) of 1^{st} wall |

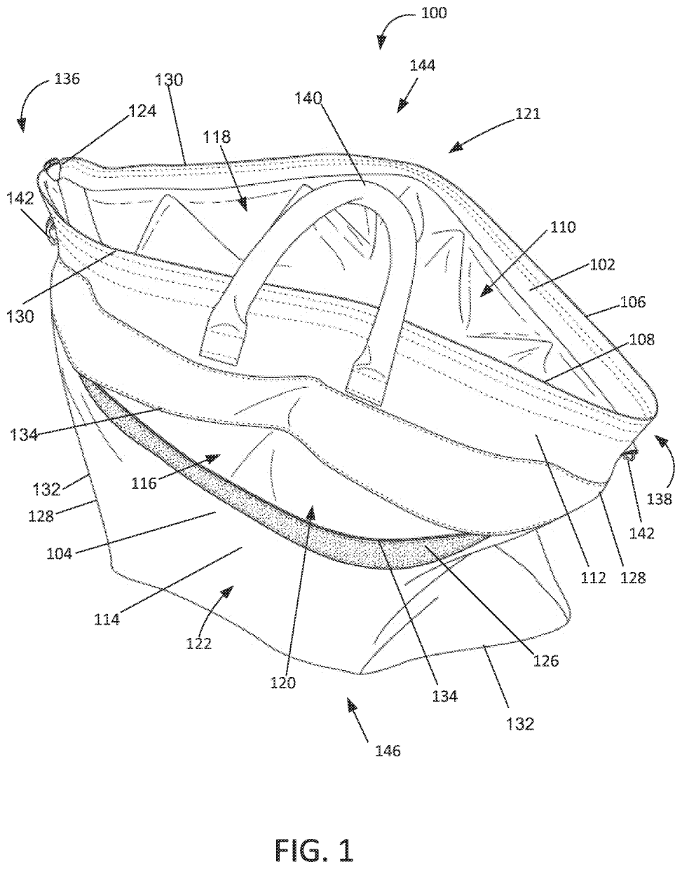

FIG. 1 is a perspective view of an example of an embodiment of a flexible helmet bag 100 that includes a first compartment 102 for holding a pilot's helmet and second compartment 104 for safely carrying, holding, and containing a mobile computer device that includes a power source (e.g., a battery). The first compartment 102 is arranged on a distal side 121 of the helmet bag 100. The second compartment 104 is arranged on a proximal side 122 of the helmet bag 100. The helmet bag 100 also has a first end 136 and the second end 138, as illustrated in FIG. 1.

The first compartment 102 is structured and sized to hold and protect a pilot's helmet. In the illustrated embodiment, the first compartment 102 can have a first wall 106, a second wall 108 coupled to the first wall 106, and a first cavity 110 between the first wall 106 and the second wall 108. The first cavity 110 has an opening 118 positioned along the top portion 144 of the helmet bag 100 which allows access into the first cavity 110. The first cavity 110 is sized and structured to hold a pilot's helmet. The first wall 106 is coupled to the second wall 108 along a first portion 128 of the perimeter of the first compartment 102. The first wall 106 can be coupled to the second wall 108 either directly or indirectly. The first portion 128 of the perimeter of the first compartment 102 runs along the sides helmet bag 100, for example, along the first end 136, the second end 138, and the bottom 146 of the helmet bag 100. The second portion 130 of the perimeter of the first compartment 102 runs along the opening 118. A first fastener 124 is coupled on or near the second portion 130 of the perimeter of the first compartment 102 and is structured with a closing mechanism for closing the opening 118. In an example, the first fastener 124 includes a zipper. In another example, the first fastener 124 includes hook and loop fasteners. In another example, the first fastener 124 includes a snap, a buckle, a button, or other fastening structure which allows the opening 118 to be securely fastened to hold helmet in the first compartment 102. In some embodiments, the first fastener 124 provides an airtight seal of the first compartment 102.

In some embodiments, the first wall 106 includes multiple layers. In some embodiments, the second wall 108 includes multiple layers. In this example, the first wall 106 and the second wall 108 each include three layers, an example of which is described in reference to FIG. 6. The first wall 106 and the second wall 108 are configured with materials to provide protection of the helmet in the first cavity 110 while still being flexible such that the helmet bag 100 can be rolled or folded up and stored in the cockpit.

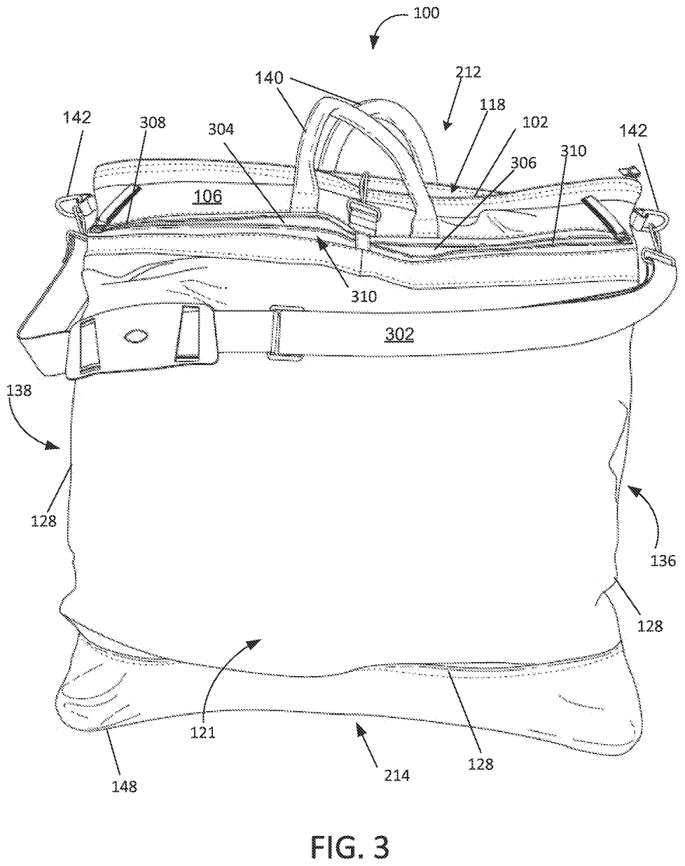

The helmet bag 100 also includes a second compartment 104 arranged on the proximal side 122 of the helmet bag 100. The second compartment 104 is coupled to the first compartment 102 such that the helmet bag 100 is an integrated article that includes (at least) the first and second compartments 102, 104. In some embodiments, the helmet bag 100 can include one or more additional compartments (e.g., as illustrated in FIG. 3) for holding a variety of items. The second compartment 104 is configured to hold and contain a lithium battery, or a mobile device having a lithium battery. The second compartment 104 has a specialized structure that is designed to contain heat, smoke, and fire that may occur when a battery undergoes a thermal ignition event.

In the illustrated embodiment, the second compartment 104 can have a third wall 112, a fourth wall 114 coupled to the third wall 112, and a second cavity 116 between the third wall 112 and the fourth wall 114. The fourth wall 114 can be coupled to the third wall 112 either directly or indirectly. The second cavity 116 has an opening 120 positioned along of near the top portion 144 of the helmet bag 100 which allows access into the second cavity 116. In this example, the opening 120 is arranged on the proximal side 122 about 2″-3″ down from the 144 of the helmet bag 100. The second cavity 116 is sized and structured to hold a mobile device. In this example, the second cavity 116 is smaller than the first cavity 110. The third wall 112 is coupled to the second wall 108. For example, the third wall 112 is coupled to the second wall 108 along the perimeter of the second wall 108, such that the third wall 112 is on the distal side 122 relative to the second wall 108. In some embodiments, the third wall 112 is coupled to the second wall 108 along portions of the second wall 108 interior to the perimeter of the second wall 108. The third wall 112 can be coupled to the second wall 108 either directly or indirectly.

The first portion 132 of the perimeter of the second compartment 104 runs along the sides helmet bag 100, for example, along the first end 136, the second end 138, and the bottom 146 of the helmet bag 100. The second portion 134 of the perimeter of the second compartment 104 runs along the opening 120. A second fastener 126 is coupled on or near the second portion 134 of the perimeter of the second compartment 104 and is structured with a closing mechanism for closing the opening 118. In preferred embodiments, the second fastener 126 is structured such that it holds the opening 120 closed but it does not provide an airtight seal to the second compartment 104, instead allowing a restricted air movement out of the second compartment 104 when the fastener 126 is positioned to close the opening 120. This will allow some air to escape the second compartment 104 preventing an explosive condition from occurring inside the second compartment. In some embodiments, the second fastener 126 includes hook and loop fasteners. In some embodiments, the second fastener 126 includes one or more of a zipper, a snap, a buckle, a button, or hook and loop fasteners, or another suitable fastening structure.

In some embodiments, the third wall 112 includes multiple layers. In some embodiments, the fourth wall 114 includes multiple layers. In this example, the third wall 112 and the fourth wall 114 each include three layers, an example of which is described in reference to FIG. 6. The third wall 112 and the fourth wall 114 are configured with materials to provide heat and fire protection from a battery or mobile device in the second compartment 104 when the battery or mobile device catches fire or otherwise has a thermal runaway event which raise the temperature of the battery or the mobile device above is normal operating temperature. In addition, the third wall 112 and the fourth wall 114 are configured with materials which are flexible such that the helmet bag 100 can be rolled or folded up and stored in the cockpit.

The helmet bag 100 can also include structures for carrying the helmet bag 100. For example, the helmet bag 100 can include one or more handles 140. In an example, the helmet bag 100 can include fasteners 142 (e.g., rings) positioned on the first and 136 and the second and 138, which are configured to attach to a strap 302 (FIG. 3).

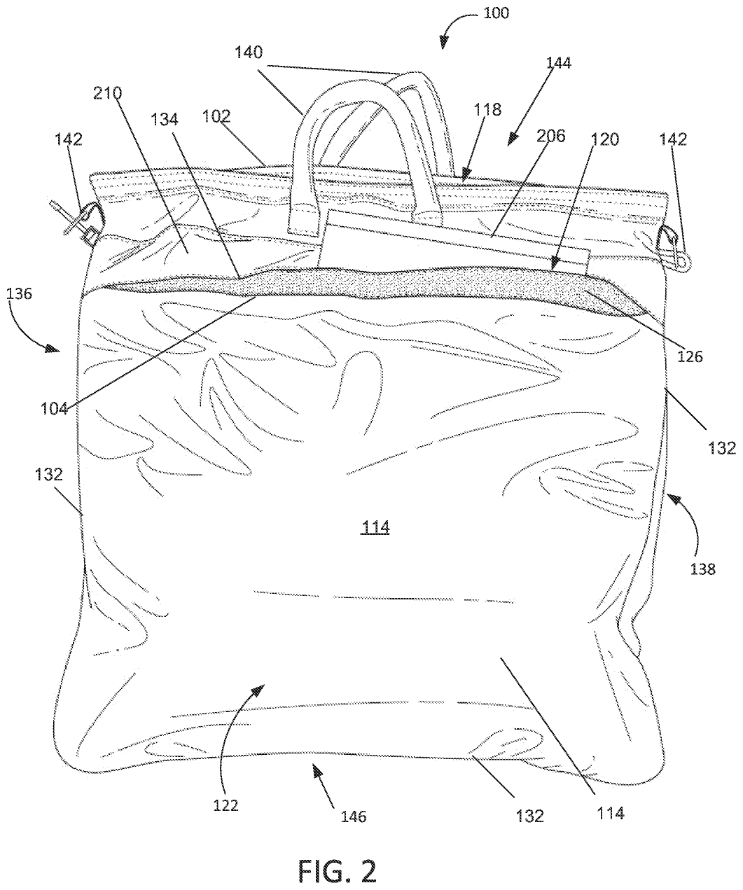

FIG. 2 is a proximal side 122 elevational view of the embodiment of the helmet bag 100 of FIG. 1. As illustrated in FIG. 2, the second cavity opening 120 is arranged to run laterally across the fourth wall 114 between the first and 136 and the second and 138 of the helmet bag 100. As an example, FIG. 2 illustrates a mobile device 206 extending out of the second cavity opening 120. In this embodiment, the second compartment 104 includes a flap 210 that extends over the second cavity opening 120 encloses the second compartment 104 using a second fastener 126 that includes hook and loop fasteners. In this example, the flap 210 constructed using the same materials as the fourth wall 114 such that the second compartment 104 is a whole provides a complete enclosure to safely hold a mobile device undergoing a thermal ignition event. The second cavity opening 120 is advantageously designed to be quickly opened to receive a mobile device 206 and then be quickly closed to contain the mobile device 206 within the second compartment 104. The second fastener 126 and the second cavity opening 120

FIG. 3 is a elevational view of a distal side of the embodiment of the helmet bag of FIG. 1. As illustrated in the embodiment of FIG. 3, the helmet bag 100 can include one or more additional compartments coupled to the first compartment 102. For example, this embodiment includes a first pocket 304 and a second pocket 306 which are arranged on the distal side 121 of the helmet bag 100 such that the first compartment 102 is between the first and second compartments 304, 306, and the second compartment 104. The first pocket 304 includes a fastener 308 for closing an opening of the first pocket 304. The second pocket 306 includes a fastener 310 for closing an opening of the second pocket 306. In various embodiments, the first and second fasteners 308, 310 can comprise a zipper, hook and loop fasteners, a snap, a buckle, or any other suitable fastener. In some embodiments, the helmet bag may include a variety of other pockets positioned on other parts of the helmet bag 100. For example, one or more pockets inside the first compartment 102 for holding items that are smaller than a helmet. FIG. 3 also illustrates a shoulder strap 302 that can be attached to the helmet bag 100 (e.g., via strap fasteners 142) for carrying the helmet bag 100.

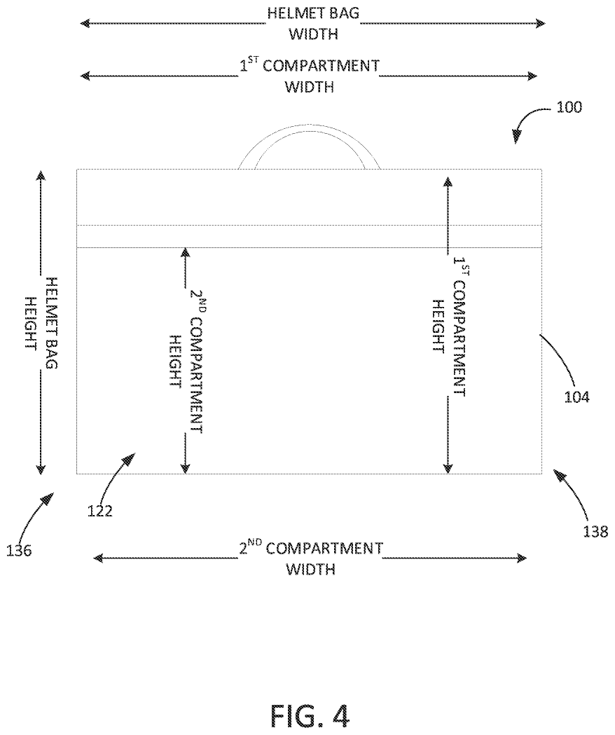

FIG. 4 is a schematic illustrating examples of dimensions of the helmet bag 100 illustrated in FIG. 1, according to various embodiments. In some embodiments, the helmet bag width can be between 15″ and 30″ wide (e.g., from the first end 136 to the second end 138). For example, in some embodiments, the helmet bag width is 15″, 16″, 17″, 18″, 19″, 20″, 21″, 22″, 23″, 24″, 25″, 26″, 27″, 28″, 29″, or 30″, plus or minus ½″. In some preferred embodiments, the helmet bag width is 17″, 18″, 19″, 20″, 21″, 22″, or 23″, plus or minus ½″. In another example of a preferred embodiment, the helmet bag width is 19″, 20″ or 21″, plus or minus ½″. In some embodiments, then helmet bag height is between 15″ and 30″. For example, in some embodiments, the helmet bag height is 15″, 16″, 17″, 18″, 19″, 20″, 21″, 22″, 23″, 24″, 25″, 26″, 27″, 28″, 29″, or 30″, plus or minus ½″. In some preferred embodiments, the helmet bag height is 17″, 18″, 19″, 20″, 21″, 22″, or 23″, plus or minus ½″. In another example of a preferred embodiment, the helmet bag height is 19″, 20″ or 21″, plus or minus ½″.

The width of the first compartment 102 can be the same width as the helmet bag, or nearly so. In an example, the width of the first compartment 102 is 17″, 18″, 19″, 20″, 21″, 22″, or 23″, plus or minus ½″. The height of the first compartment 102 can be the height of the helmet bag, or nearly so. In an example, the height of the first compartment is between 17″, 18″, 19″, 20″, 21″, 22″, or 23″, plus or minus ½″.

The width of the second compartment 104 can be the same width as the helmet bag, or nearly so. In an example, the width of the second compartment 104 is between 10″ and 23″. In an example, the width of the second compartment can be 10″, 11″, 12″, 13″, 14″, 15″, 16″, 17″, 18″, 19″, 20″, 21″, 22″, or 23″, plus or minus ½″. The height of the second compartment 104 can be about the height of the helmet bag, or nearly so. For example, 17″, 18″, 19″, 20″, 21″, 22″, or 23″, plus or minus ½″. In some preferred embodiments, the height of the second compartment 104 is less than the height of the helmet bag. In an example, the height of the second compartment 104 is between 7″ and 22″ (e.g., where the height of the helmet bag is at least 22″. For example, the height of the second compartment 104 7″, 8″, 9″, 10″, 11″, 12″, 13″, 14″, 15″, 16″, 17″, 18″, 19″, 20″, 21″, or 22″ plus or minus ½″. Other embodiments can have other dimensions. For example, for a particular pilot helmet that includes low-light or night vision systems, the helmet bag can be configured to be sized to hold such a helmet.

The helmet bag can be configured/sized to accommodate various sizes of helmets and devices. When the helmet bag is empty and compressed, in some embodiments the helmet bag can have a depth dimension (e.g., from the proximal side 122 to the distal side 121) of between ¾″ and 3″. In some preferred embodiments, the helmet bag can have a depth dimension (when compressed) of about 1″, plus or minus 1″. The particular construction of the first, second, third and fourth walls affect the helmet bag depth. Any of the first, second, third, and fourth walls can include multiple layers of materials. For example, FIG. 6 illustrates an embodiment where each of the first, second, third, and fourth walls include three layers of material. In some embodiments, the layers of a wall can be coupled together around the perimeter of the layers. In some embodiments, the layers of a wall can be coupled together at the perimeter and one or more places interior to the perimeter. In some embodiments, the layers of a wall are tightly coupled together forming a composite layer such that surfaces of the layers are positioned tightly adjacent to each other.

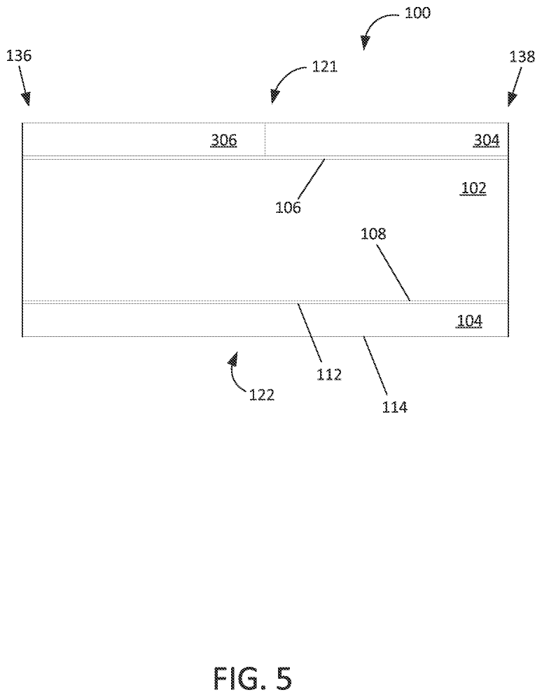

FIG. 5 is a schematic illustrating a top view of an example of a helmet bag, for example, the helmet bag 100 illustrated FIG. 1. FIG. 5 further illustrates the arrangement of the first and second compartments 102, 104. The first compartment 102 includes a first wall 106 positioned on the distal side 121 of the first compartment 102, and a second wall 108 positioned on the proximal side 122 of the first compartment 102. The first cavity 110 (FIG. 1) is between the first wall 106 and the second wall 108. In this example, helmet bag 100 includes a first pocket 304 and a second pocket 306 coupled to the first wall 102.

The second compartment 104 includes a third wall 112 on the distal side 121 of the second compartment 104. The third wall 112 is adjacent to, and coupled to, the second wall 108. The second compartment 104 also includes a fourth wall 114 on the proximal side 122 of the second compartment 104. The second cavity 116 (FIG. 1) is between the third wall 112 and the fourth wall 114. Any or all of the first, second, third and fourth walls 106, 108, 112, 114 may include multiple materials. For example, any or all of the first, second, third and fourth walls 106, 108, 112, 114 may include two or more layers of material. An example of an embodiment where the first, second, third and fourth walls 106, 108, 112, 114 each includes three layers of material is illustrated in FIG. 6.

FIG. 6 is an exploded perspective view illustrating an example of the structure of the first compartment 102 and the second compartment 104 of the helmet bag 100. In this example, first, second, third, and fourth walls 106, 108, 112, 114 that form the first compartment 102 and the second compartment 104, respectively, each include at least three layers of material to provide a specific functionality for each compartment. The layers of material are illustrated as they are arranged in the helmet bag 100, with the first wall 106 on the distal side 121 of the helmet bag 100 and the fourth wall 114 on the proximal side 114 of the helmet bag 100. Although designed to be strong, fire-proof/fire-resistant, and explosive resistant, the first, second, third, and fourth walls 106, 108, 112, 114 are also flexible such that the helmet bag can be rolled-up or folded for easy storage.

The first compartment 102 includes a first wall 106 and a second wall 108. The first cavity 110 is between the first wall 106 and the second wall 108. In this example, the first wall 106 includes a first material 624 as an outer layer, a second material 622 as a middle layer, and a third material 620 as an inner layer (closest to the cavity 110). The second material 622 is positioned between the first material 624 and the third material 620 of the first wall 106. In an example of the configuration of the first wall 106, the first material 624 comprises nylon, the second material 622 comprises a cotton rill, and the third material 620 comprises nylon.

As illustrated in the example of FIG. 6, the second wall 108 includes a first material 614 as an outer layer, a second material 616 as a middle layer, and a third material 618 as an inner layer (closest to the cavity 110). The second material 616 is positioned between the first material 614 and the third material 618 of the second wall 106. In an example of the configuration of the second wall 108, the first material 614 comprises nylon, the second material 616 comprises a cotton rill, and the third material 618 comprises nylon. The cotton rill provides padding to protect contents of the first compartment. Other materials can be used in the first and second wall that are suitable for protecting the helmet (when contained in the first compartment) from impacts, for example, if the bag is dropped or contacts another object when the helmet bag is being carried.

The second compartment includes a third wall 112 and a fourth wall 114. The second cavity 116 is between the third wall 112 and the fourth wall 114. In this example, the second wall 112 includes a first material 612 as an outer layer, a second material 610 as a middle layer, and a third material 608 as an inner layer (closest to the cavity 116). The second material 610 is positioned between the first material 612 and the third material 608 of the third wall 112. In a first example of the configuration of the third wall 112, the first material 612 comprises Kevlar, the second material 610 comprises a silica fabric, and the third material 608 comprises fiberglass. In a second example of the configuration of the third wall 112, the first material 612 comprises Kevlar, the second material 610 comprises carbon fiber, and the third material 608 comprises fiberglass. In a third example of the configuration of the third wall 112, the first material 612 comprises Nomex, the second material 610 comprises silica fabric, and the third material 608 comprises fiberglass. In a fourth example of the configuration of the third wall 112, the first material 612 comprises Nomex, the second material 610 comprises carbon fiber, and the third material 608 comprises fiberglass. In a fifth example of the configuration of the third wall 112, the first material 612 comprises aramid fibers, the second material 610 comprises silica fabric, and the third material 608 comprises fiberglass. In a sixth example of the configuration of the third wall 112, the first material 612 comprises an aramid fabric, the second material 610 comprises carbon fiber, and the third material 608 comprises fiberglass.

The layers of the fourth wall can include similar materials as the third wall. In a first example of the configuration of the fourth wall 114, the first material 602 comprises Kevlar, the second material 604 comprises a silica fabric, and the third material 606 comprises fiberglass. In a second example of the configuration of the fourth wall 114, the first material 602 comprises Kevlar, the second material 604 comprises carbon fiber, and the third material 606 comprises fiberglass. In a third example of the configuration of the fourth wall 114, the first material 602 comprises Nomex, the second material 604 comprises silica fabric, and the third material 606 comprises fiberglass. In a fourth example of the configuration of the fourth wall 114, the first material 602 comprises Nomex, the second material 604 comprises carbon fiber, and the third material 606 comprises fiberglass. In a fifth example of the configuration of the fourth wall 114, the first material 602 comprises an aramid material, the second material 604 comprises silica fabric, and the third material 606 comprises fiberglass. In a sixth example of the configuration of the fourth wall 114, the first material 602 comprises an aramid material, the second material 604 comprises carbon fiber, and the third material 606 comprises fiberglass.

### Implementation Consideration

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Headings are included herein for reference and to aid in locating various sections. These headings are not intended to limit the scope of the concepts described with respect thereto. Such concepts may have applicability throughout the entire specification.

Many variations and modifications may be made to the above-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

It will also be understood that, when a feature or element (for example, a structural feature or element) is referred to as being “connected”, “attached” or “coupled” to another feature or element, it may be directly connected, attached or coupled to the other feature or element or intervening features or elements may be present. In contrast, when a feature or element is referred to as being “directly connected”, “directly attached” or “directly coupled” to another feature or element, there may be no intervening features or elements present. Although described or shown with respect to one embodiment, the features and elements so described or shown may apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments and implementations only and is not intended to be limiting. For example, as used herein, the singular forms “a”, “an” and “the” may be intended to include the plural forms as well, unless the context clearly indicates otherwise. It will be further understood that the terms “comprises” and/or “comprising,” when used in this specification, specify the presence of stated features, steps, operations, processes, functions, elements, and/or components, but do not preclude the presence or addition of one or more other features, steps, operations, processes, functions, elements, components, and/or groups thereof. As used herein, the term “and/or” includes any and all combinations of one or more of the associated listed items and may be abbreviated as “/”.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

Spatially relative terms that may be used herein, for example, “top,” “bottom,” “forward,” “rearward,” “under,” “below,” “lower,” “over,” “upper,” “distal,” “proximal” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features due to the inverted state. Thus, the term “under” may encompass both an orientation of over and under, depending on the point of reference or orientation. The device may be otherwise oriented (rotated 90 degrees or at other orientations) and the spatially relative descriptors used herein interpreted accordingly. Similarly, the terms “upwardly”, “downwardly”, “vertical”, “horizontal” and the like may be used herein for the purpose of explanation only unless specifically indicated otherwise.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise.

For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, may represent endpoints or starting points, and ranges for any combination of the data points. For example, if a particular data point “10” and a particular data point “15” may be disclosed, it is understood that greater than, greater than or equal to, less than, less than or equal to, and equal to 10 and 15 may be considered disclosed as well as between 10 and 15. It is also understood that each unit between two particular units may be also disclosed. For example, if 10 and 15 may be disclosed, then 11, 12, 13, and 14 may be also disclosed.

Although various illustrative embodiments have been disclosed, any of a number of changes may be made to various embodiments without departing from the teachings herein. Optional or desirable features of various device and system embodiments may be included in some embodiments and not in others. Therefore, the foregoing description is provided primarily for the purpose of example and should not be interpreted to limit the scope of the claims and specific embodiments or particular details or features disclosed.

The examples and illustrations included herein show, by way of illustration and not of limitation, specific embodiments in which the disclosed subject matter may be practiced. As mentioned, other embodiments may be utilized and derived therefrom, such that structural and logical substitutions and changes may be made without departing from the scope of this disclosure. Such embodiments of the disclosed subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve an intended, practical or disclosed purpose, whether explicitly stated or implied, may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The disclosed subject matter has been provided here with reference to one or more features or embodiments. Those skilled in the art will recognize and appreciate that, despite of the detailed nature of the example embodiments provided here, changes and modifications may be applied to said embodiments without limiting or departing from the generally intended scope. These and various other adaptations and combinations of the embodiments provided here are within the scope of the disclosed subject matter as defined by the disclosed elements and features and their full set of equivalents.

What is claimed is:

1. A helmet bag with an integrated thermal containment compartment, the helmet bag, comprising:
a first compartment including
a flexible first wall positioned on a distal side of the helmet bag,
a flexible second wall,
a first cavity between the first wall and the second wall for holding a helmet, the first wall coupled to the second wall along a first portion of a perimeter of the first cavity,
a first opening along a second portion of the perimeter of the first cavity for receiving a helmet into the first cavity, and
a first fastener attached along the second portion of the first compartment, the first fastener configured to temporarily close the first opening;
a second compartment including
a flexible third wall coupled to the second wall,
a flexible fourth wall positioned on the proximal side of the helmet bag such that the third wall is between the first compartment and the fourth wall,
a second cavity between the third wall and the fourth wall for holding an electronic device, the third wall coupled to the fourth wall along a first portion of a perimeter of the second cavity, wherein the third wall includes an inner layer comprising fiberglass material positioned adjacent to the second cavity, an outer layer comprising an aramid material, and a middle layer comprising one of a silica fabric material or a carbon fiber material positioned between the inner layer and the outer layer, and wherein the fourth wall includes an inner layer comprising fiberglass material positioned adjacent to the second cavity, an outer layer comprising an aramid material, and a middle layer comprising one of a silica fabric material or a carbon fiber material positioned between the inner layer and the outer layer of the fourth wall,
a second opening along a second portion of the perimeter of the second cavity for receiving an electronic device into the second cavity, and
a second fastener attached along the second portion of the perimeter of the second cavity, the second fastener configured to temporarily close the second opening.

2. The helmet bag of claim 1, wherein the width of the second compartment is less than or equal to the width of the first compartment, and the height of the second compartment is less than or equal to the height of the first compartment.

3. The helmet bag of claim 1, wherein the volume of the first cavity is greater than the volume of the second cavity.

4. The helmet bag of claim 1, wherein the middle layer of the third wall and the middle layer of the fourth walls include silica fabric material.

5. The helmet bag of claim 1, wherein the middle layer of the third wall and the middle layer of the fourth walls include carbon fiber material.

6. The helmet bag of claim 1, wherein the width dimension of the first compartment and the width dimension of the second compartment are within plus or minus 2″ of each other.

7. The helmet bag of claim 1, wherein the first compartment has a height of between 15″ and 30″ and a width of between 15″ and 30″.

8. The helmet bag of claim 1, wherein the second compartment has a height dimension of between 7″ and 22″ and a width dimension of between 10″ and 23″.

9. The helmet bag of claim 1, wherein the second fastener is configured to close the second opening with a non-airtight seal.

10. The helmet bag of claim 9, wherein the second fastener comprises hook-and-loop fasteners.

11. The helmet bag of claim 9, wherein the second fastener comprises one of a zipper, hook and loop fasteners, a snap, a button, or a structure that extends over the opening and covers the opening.

12. A helmet bag with an integrated thermal containment compartment, the helmet bag, comprising:
a first compartment including
a flexible first wall positioned on a distal side of the helmet bag,
a flexible second wall,
a first cavity between the first wall and the second wall having dimensions for holding a pilot's helmet, the first wall coupled to the second wall along a first portion of a perimeter of the first cavity,
a first opening along a second portion of the perimeter of the first cavity for receiving a helmet into the first cavity, and
a first fastener attached along the second portion of the first compartment, the first fastener configured to temporarily close the first opening;
a second compartment including
a flexible third wall coupled to the second wall,
a flexible fourth wall positioned on the proximal side of the helmet bag such that the third wall is between the first compartment and the fourth wall,
a second cavity between the third wall and the fourth wall having dimensions for holding an electronic device, the third wall and the fourth wall each comprising two or more layers of material and are structured to contain heat and smoke of a thermal runaway event of an electronic device in the second compartment,
a second opening along a second portion of the perimeter of the second cavity for receiving an electronic device into the second cavity, and
a second fastener attached along the second portion of the perimeter of the second cavity, the second fastener configured to temporarily close the second opening.

13. The helmet bag of claim 12, wherein the third wall and the fourth wall each comprise a flexible outer layer comprising Nomex®, a flexible middle layer comprising silica fabric, and a flexible inner layer comprising fiberglass.

14. The helmet bag of claim 12, wherein the third wall and the fourth wall each comprise a flexible outer layer comprising Nomex®, a flexible middle layer comprising carbon fiber, and a flexible inner layer comprising fiberglass.

15. The helmet bag of claim 12, wherein the first compartment has a height of between 15″ and 30″ and a width of between 15″ and 30″.

16. The helmet bag of claim 12, wherein the second compartment has a height dimension of between 7″ and 22″ and a width dimension of between 10″ and 23″.

17. The helmet bag of claim 12, wherein the second fastener is configured to close the second opening with a non-airtight seal.

18. The helmet bag of claim 17, wherein the second fastener comprises hook-and-loop fasteners.

19. A helmet bag with an integrated thermal containment compartment, the helmet bag, comprising:
a first compartment including a flexible first wall positioned on a distal side of the helmet bag, a flexible second wall, and a first cavity between the first wall and the second wall having dimensions for holding a pilot's helmet, the first wall coupled to the second wall along a first portion of a perimeter of the first cavity,
a second compartment including a flexible third wall coupled to the second wall, a flexible fourth wall positioned on the proximal side of the helmet bag such that the third wall is between the first compartment and the fourth wall, a second cavity between the third wall and the fourth wall having dimensions for holding an electronic device, the third wall and the fourth wall each comprising two or more layers of material and are structured to contain heat and smoke of a thermal runaway event of an electronic device in the second compartment, and a second fastener attached along an opening on a perimeter of the second cavity, the second fastener configured to temporarily close the opening with a non-airtight seal.

20. The helmet bag of claim 19, wherein the third wall and the fourth wall each comprise a flexible outer layer comprising Nomex®, a flexible middle layer comprising one of silica fabric or carbon fiber, and a flexible inner layer comprising fiberglass.
